(19) United States
(12) Patent Application Publication
(10) Pub. No.: US 2016/0229109 A1
(43) Pub. Date: Aug. 11, 2016

(54) COMPOSITE ROD WITH CONTIGUOUS END TERMINATIONS AND METHODS FOR MAKING THEM

(71) Applicant: Future Fibres, LLC, North Kingstown, RI (US)

(72) Inventors: Matthew Zach Shapiro, Newport, RI (US); Scott Louis Vogel, Jamestown, RI (US); Nicholas John Christensen, Newport, RI (US); George Reekie, Bristol, RI (US); Carrick John Hill, Auckland (NZ)

(73) Assignee: FutureFibres LLC, North Kingstown, RI (US)

(21) Appl. No.: 15/021,621

(22) PCT Filed: Sep. 12, 2014
(86) PCT No.: PCT/US2014/055478

§ 371 Date: Mar. 11, 2016

Related U.S. Application Data
(60) Provisional application No. 61/877,199, filed on Sep. 12, 2013.

(51) Int. Cl. B29C 53/36; B29C 53/84; B29C 70/28; B29C 53/08

(52) U.S. Cl. CPC B29C 53/36; B29C 53/083; B29C 53/84; B29C 70/28; B29K 2063/00

(57) ABSTRACT

A composite rod that has subsequently been reduced to its tow or whose supporting matrix has been modified by any of various means, including heat, can easily be redirected around an arc to manufacture a longitudinal structural element having a termination or support.

### BACKGROUND

The invention relates to construction of longitudinal structural elements such as stays used in rigging sailboats and other structural applications, using fiber reinforced composites such as carbon fiber and resin.

### SUMMARY

According to aspects of embodiments of the invention, a method of producing an integrated rigging component comprises steps of: providing at least one composite rod including a plurality of generally longitudinally oriented fibers and a supporting matrix generally surrounding and filling interstices between the plurality of generally longitudinally oriented fibers, the composite rod having a characteristic minimum bend radius; modifying a characteristic of the supporting matrix along a section of the composite rod such that the section of the composite rod has a new minimum bend radius different from a characteristic minimum bend radius of an unmodified section of the composite rod; bending the modified section of the composite rod; and reintegrating supporting matrix along the modified section with matrix of the unmodified section. In a variation, modifying further comprises removing the supporting matrix. In another variation, modifying further comprises softening the supporting matrix. Yet another variation comprises heating the matrix at least sufficiently to vaporize the matrix without substantially damaging the fibers, i.e. without rendering the fibers inadequate to support a desired load. In a further variation, the heating is at least sufficient to decompose the matrix without substantially damaging the fibers. Even another variation includes contacting the matrix with a substance chemically reactive therewith, such that a physical property of the matrix is modified. The method may further include contacting the matrix with a solvent, such that a physical property of the matrix is modified. The method may yet further include applying a mechanical force to the matrix, such that a physical property of the matrix is modified, including applying a mechanical force comprises localized ultrasonic disruption of the matrix. Removing matrix may include heating the matrix at least sufficiently to vaporize the matrix without substantially damaging the fibers, for example by conducting an electrical current through the fibers along the section of the composite rod. Such variations may include applying a source of flame to the section of the composite rod or directing a stream of heated fluid onto the section of the composite rod, such as blown hot air. Reintegrating may further include embedding the modified section of the composite rod in a new supporting matrix contiguous with the unmodified section. The method may further include re-hardening the supporting matrix of the modified section of the composite rod.

According to other aspects of embodiments of the invention an article of manufacture includes a bundle of composite rods, each composite rod including a plurality of generally longitudinally oriented fibers and a supporting matrix generally surrounding and filling interstices between the plurality of generally longitudinally oriented fibers, the composite rod having a characteristic minimum bend radius; and a bend feature formed in a segment of the bundle of rods such that the bend has a bend radius different from the characteristic minimum bend radius, a combined plurality of generally longitudinally oriented fibers of the bundle of rods following the bend radius, and the combined plurality of generally longitudinally oriented fibers bonded together along the segment by a supporting matrix generally surrounding and filling interstices between the combined plurality of generally longitudinally oriented fibers. In a variation, the bend feature comprises a bond and the bundle of rods includes a rod having unmodified segments, on either end of the bond, the article further comprising, but not requiring, a throat through which the two unmodified segments join contiguously with a segment of the rod surrounding the eye. Another variation includes a second bond having a segment of the rod joined through a throat contiguously with the other unmodified segments. According to yet another variation, the article further comprises a tapered termination in which the bundle of rods is embedded in a plug of supporting matrix having a tapered longitudinal profile. Another variation includes a third bond having a segment of the rod joined contiguously between the other bonds or the bond and tapered profile. Another variation includes modifying a previously unmodified section of the bundle of rods to create a bend feature consisting of a bond after the original time of manufacture.

In the following description, reference is made to the accompanying drawings, which form a part hereof, and in which are shown example implementations. It should understood that other implementations are possible, and that these example implementations are intended to be merely illustrative.

DESCRIPTION OF THE DRAWINGS

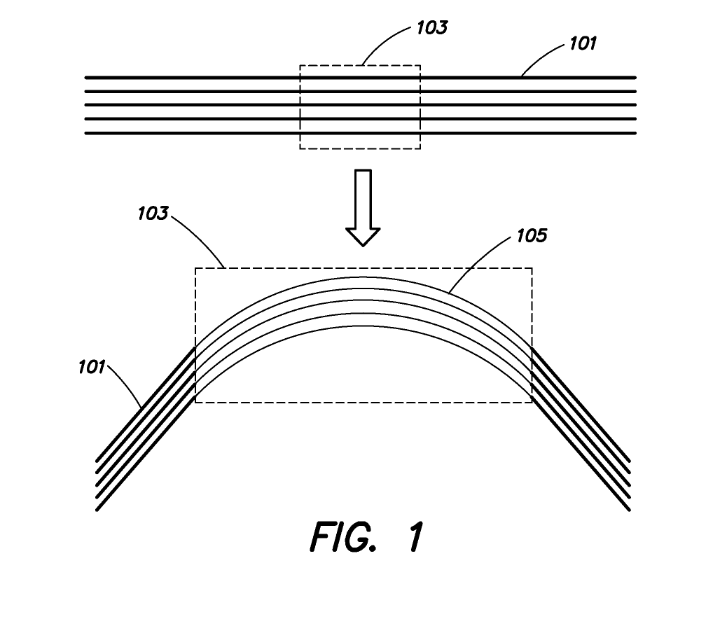

FIG. 1 is a schematic representation of a bundle of composite rods having a region modified to permit bending.

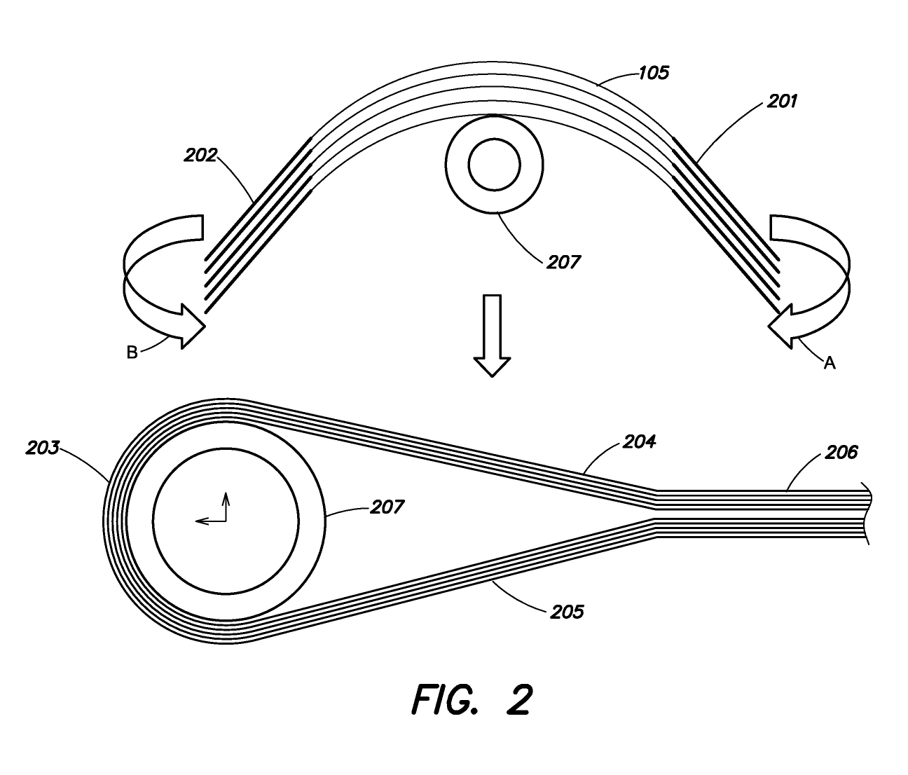

FIG. 2 is a schematic representation of the bundle of composite rods of FIG. 1 being bent around a mandrel to form a termination eye in one exemplary embodiment of the invention.

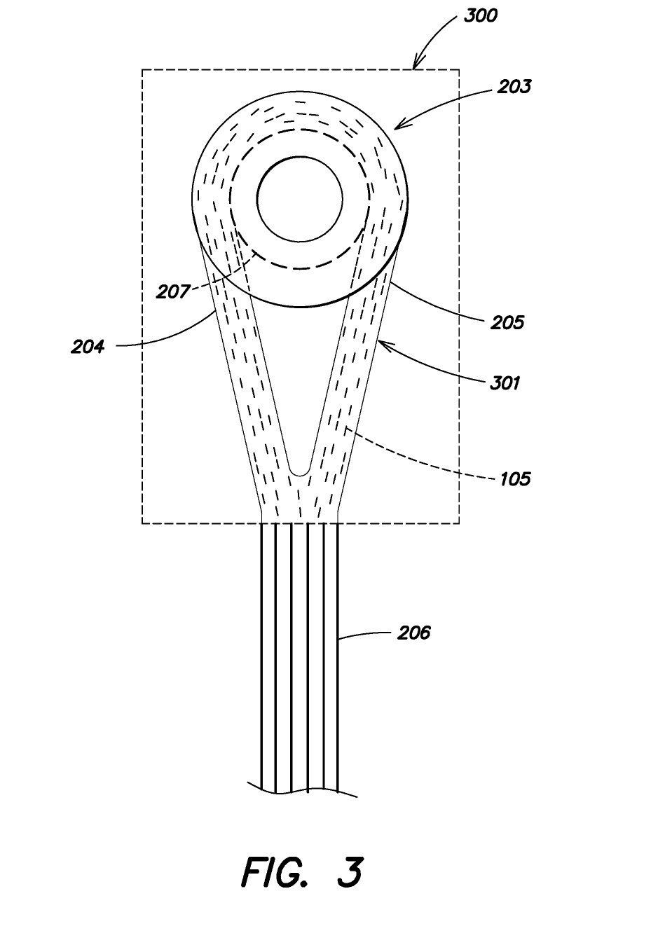

FIG. 3 is a detail of the exemplary eye embodying aspects of the invention.

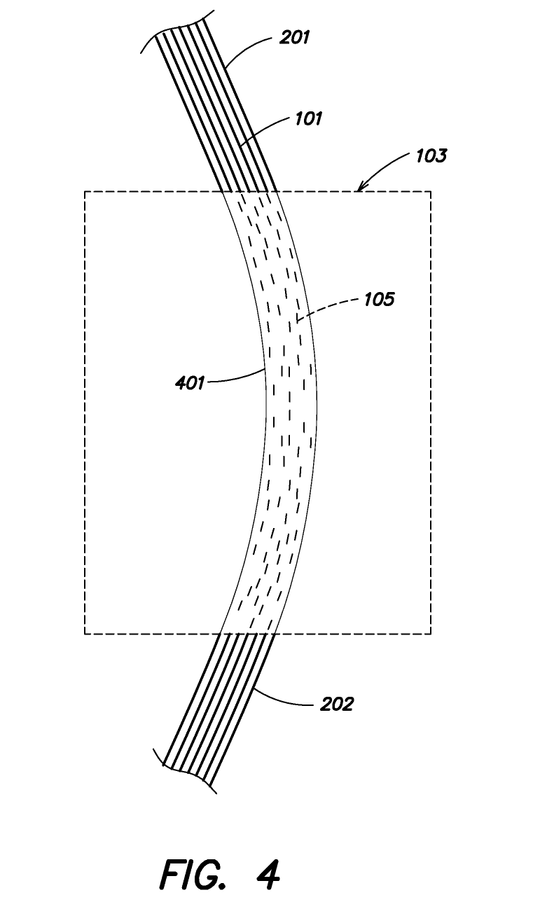

FIG. 4 is a detail of the bend region of the example of FIG. 2.

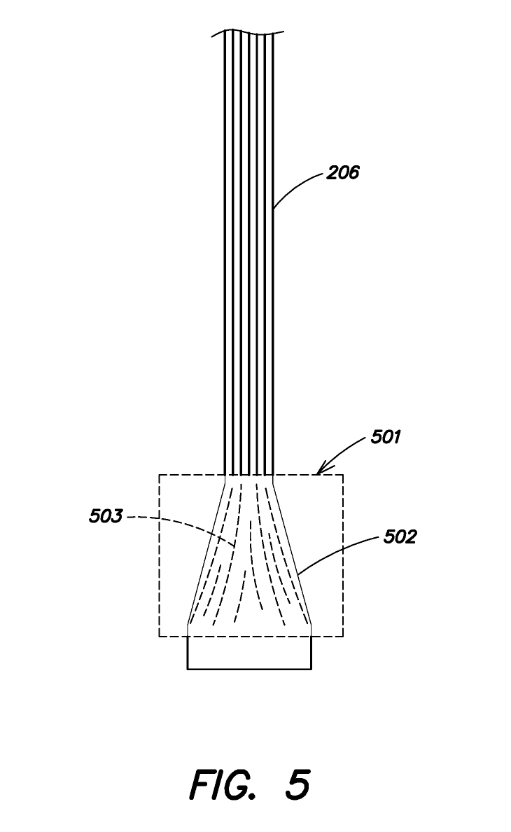

FIG. 5 is a detail of a different exemplary embodiment in which the bend region is a terminal plug at the end of a bundle of composite rods.

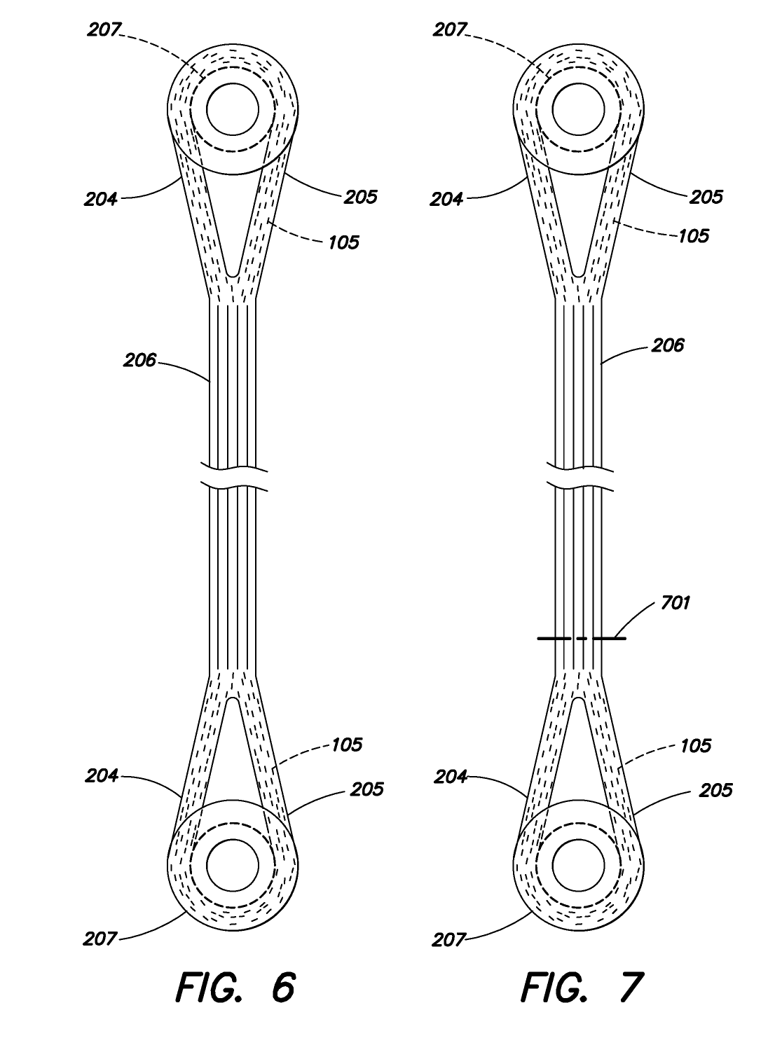

FIG. 6 is a schematic representation of a bundle of composite rods terminated at both ends by contiguous eye-shaped bend region.

FIG. 7 illustrates how the example of FIG. 6 may be modified to provide an alternative termination after construction.

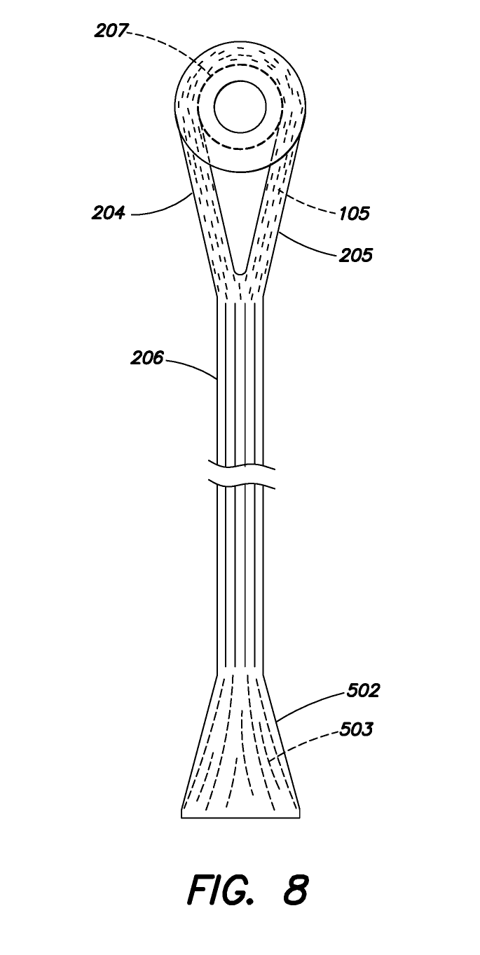

FIG. 8 illustrates the example of FIG. 7 with a plug termination.

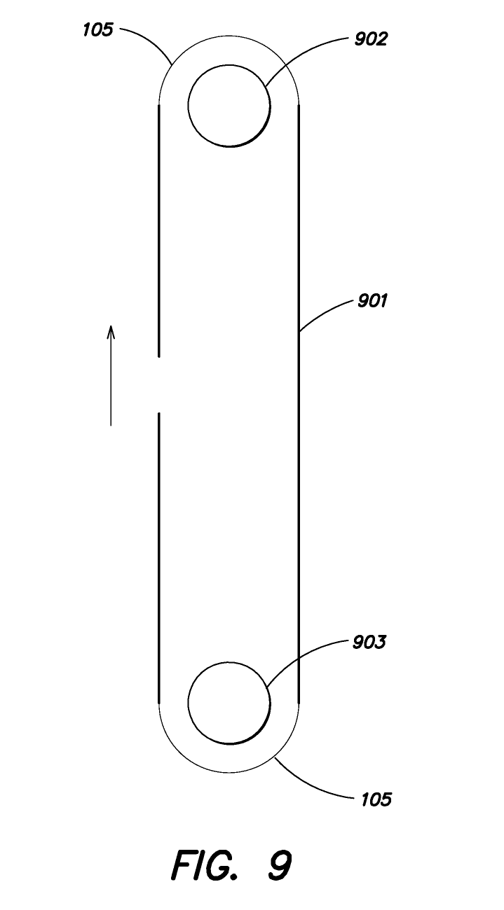

FIG. 9 is a schematic of a bundle-manufacturing setup including provision for terminating both ends contiguously with the bundle.

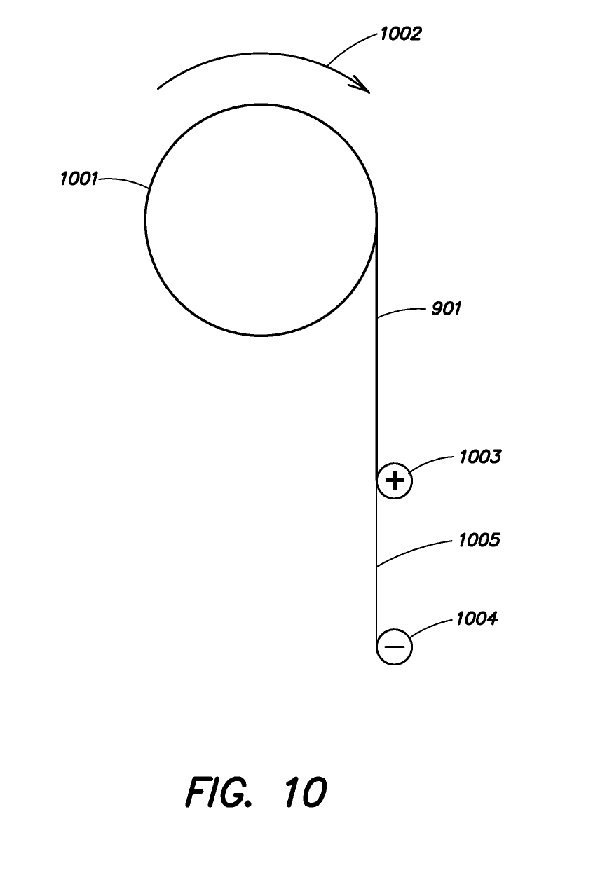

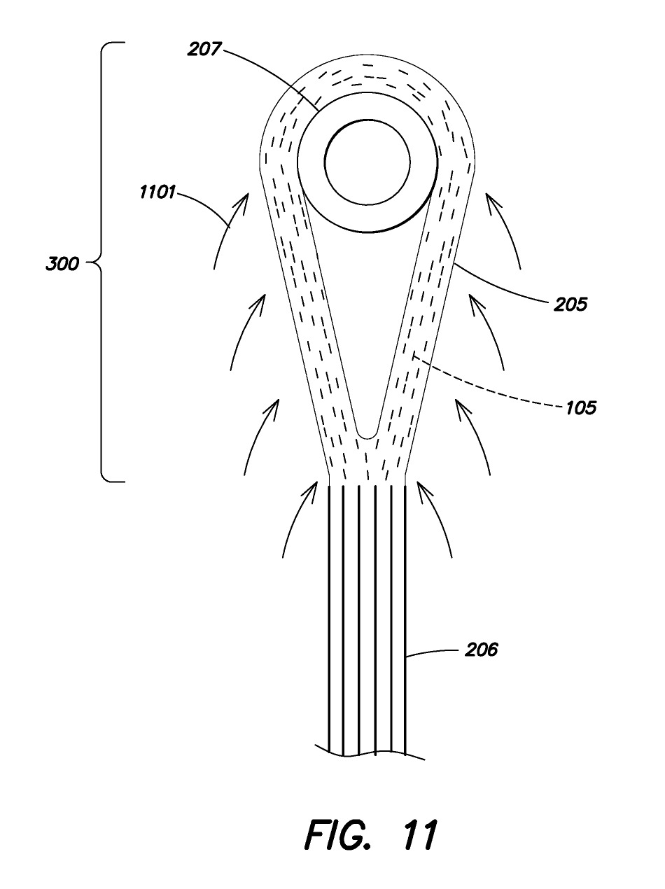

FIG. 10 is a schematic of an exemplary electrical heating method used with the setup of FIG. 9.

FIG. 11 is a schematic of a contiguous eye-shaped bend region whose strength is supplemented by the addition of fibers to the region.

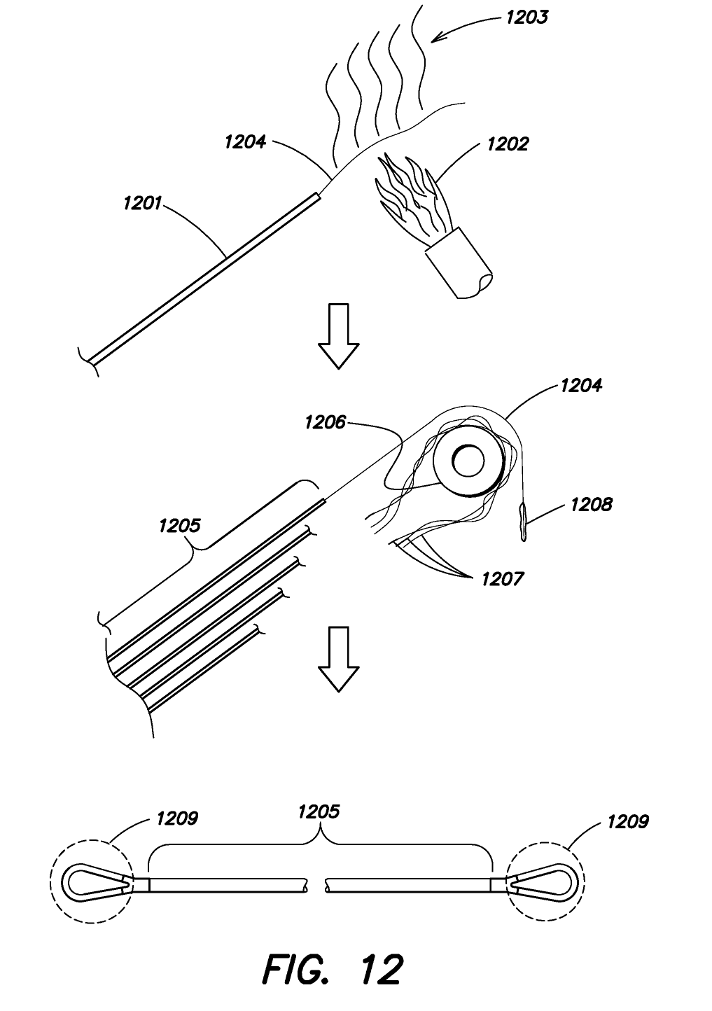

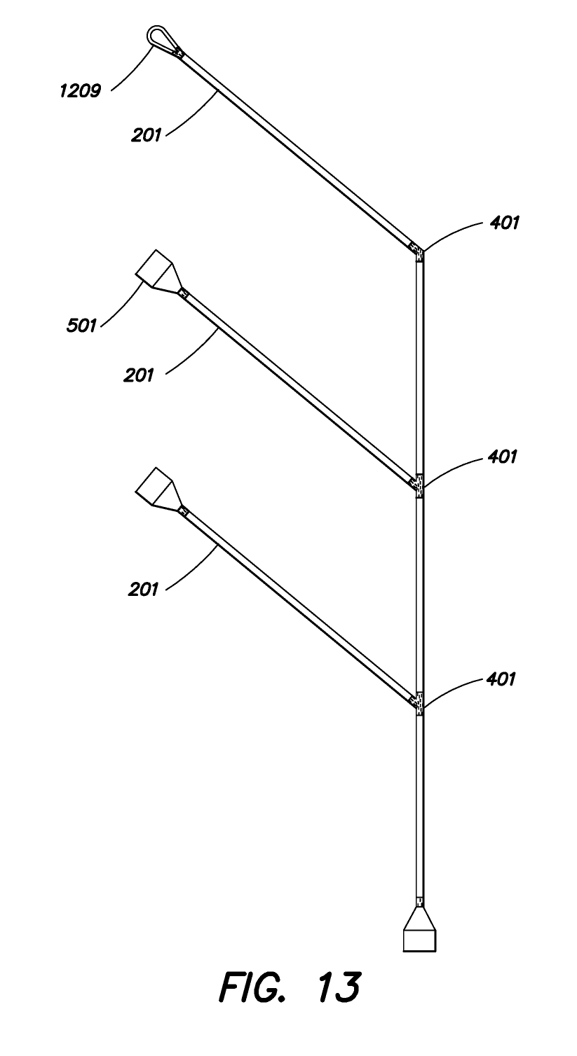

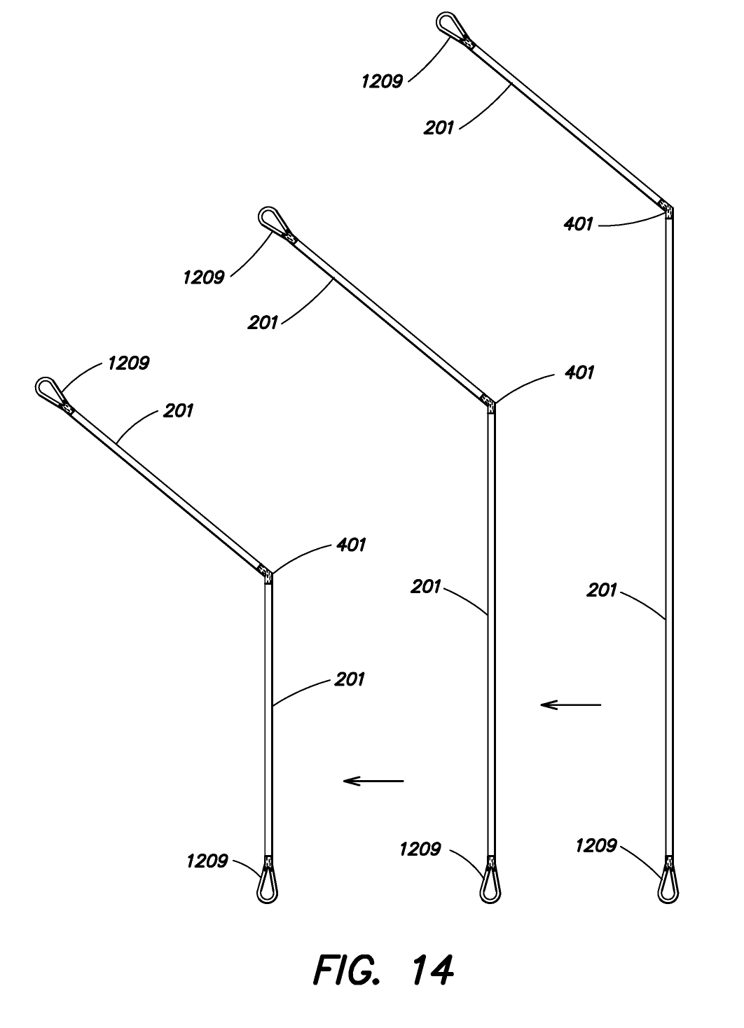

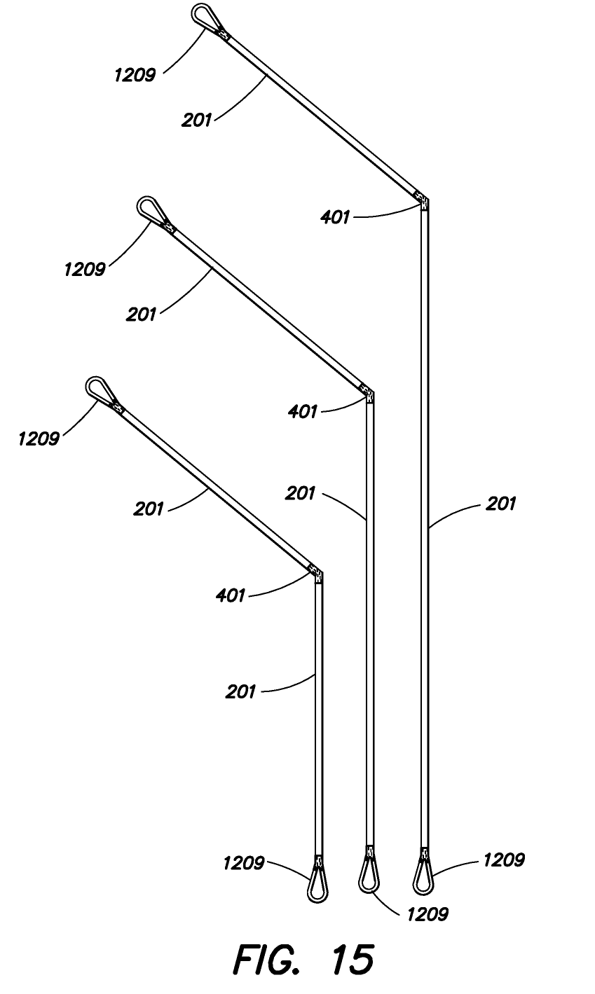

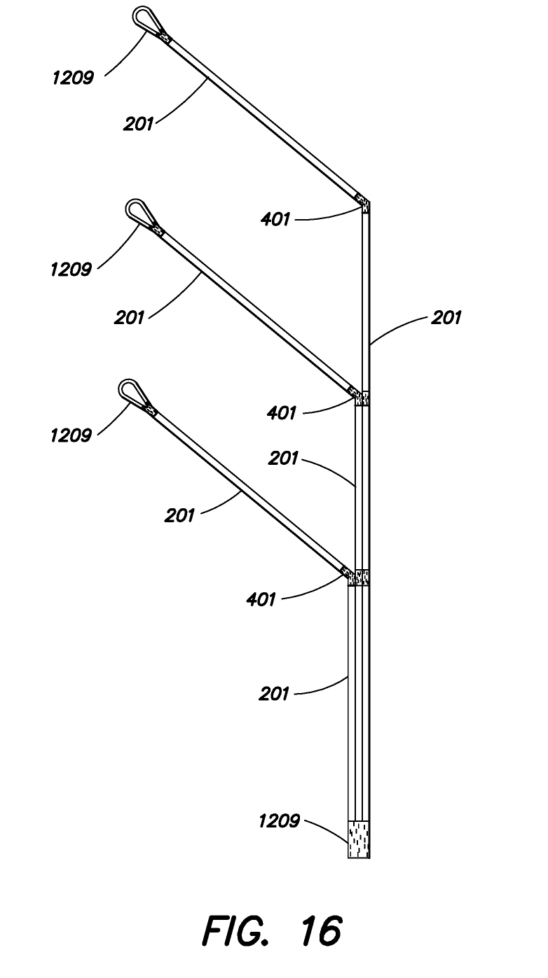

FIGS. 12-16 illustrate methods of making sailboat stays of bundled composite rods with intermediate bends, spreader supports, and end terminations formed using aspects of embodiments of the invention.

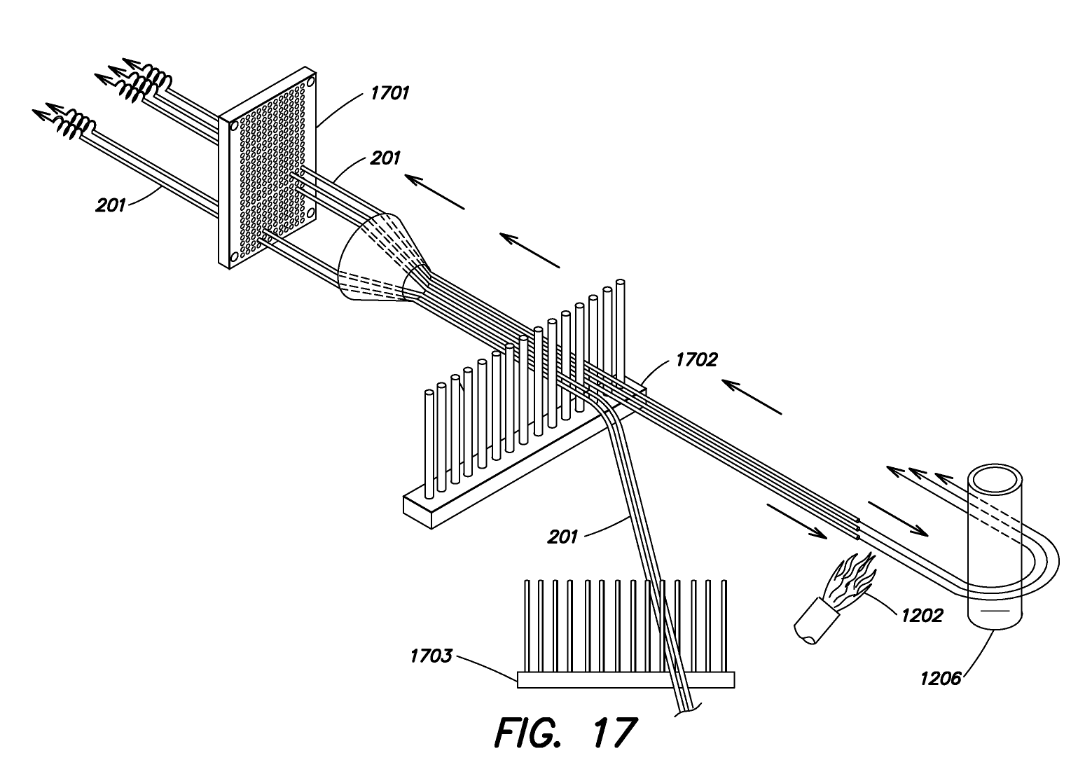

FIG. 17 illustrates a different exemplary setup from that of FIG. 9 for forming an end termination or other bend region using a direct heating method.

### DETAILED DESCRIPTION

The following section provides descriptions of various examples and variations of aspects and embodiments of the invention.

Carbon composite stay manufacturing includes the formation or addition of terminations, bends, or supports to fix, attach, pin, or support the stay at its ends and intermediary points between the ends. Performance requirements provide motivation to reduce the weight and overall size of the terminations, as well as increase efficiency when higher modulus fiber types, such as carbon fiber, high modulus carbon fiber, pitch fiber, fiberglass, polyamid, polyaramid or other suitable fiber types, are desired. Reducing the weight, size, and increasing the efficiency of the termination reduces the overall weight of the stay and allows the terminations to fit into smaller fixtures or supports for the stay.

A device, system and method, utilizes heat, chemical, or mechanical means to selectively remove or modify the resin or other supportive matrix, for example an epoxy, including phenyl epoxy compounds, polyester, thermoplastic or similar resin, from composite rod, for example a rod produced by pulling a fiber tow through a resin or other matrix to form a composite linear structural component. The invention may be practiced using composite rod produced by any other suitable process. Applying heat or flame to a carbon fiber composite rod composed of a carbon tow supported by a resin matrix causes the resin to melt, evaporate, and/or burn off, leaving the carbon tow. After removing the resin from the rod by means of heat, the tow substantially retains its strength and is flexible which allows it to be bent around an arc of a different radius than that possible before removing or modifying the resin. The flexible fibers, after being formed into a desired shape, can then be saturated with a new quantity of uncured resin or the modified resin again, for example by hardening, and bonded together into a homogeneous structure, such as an eye usable as a termination, or a bend by which the direction of pull of a stay is altered at a spreader end or other fixture redirecting the stay. The resulting termination or bend has lower weight as well as size when compared to typical terminations of composite rod structures. The addition of reinforcement fibers during the process of adding the new quantity of uncured resin controls the strength of the termination.

The device, system and method can be coupled with typical methods for manufacturing terminations of composite structures, allowing for a variety of solutions depending on the specific application.

FIG. 1 shows a bundle of composite rods, which may be pultruded rod or other suitable rod as described herein, initially in a straight, linear, parallel configuration. This initial configuration is only a representative example of the rod in a relaxed state. A region of the rod is modified, for example by application of heat, to remove or soften the resin portion of the composite. Suitably modified, the rod may be bent around a radius, and thus formed into a termination, support, or other structure.

As shown in FIG. 2, the radius that may be achieved with the method of FIG. 1 may be substantially smaller than the radius otherwise achieved by bending the composite rod. In this example, the segments of the rods to either side of the modified region are brought together and parallel, forming an eye termination at an end of a bundle having double the number of parallel rod segments as the number of initial rods. The final structure of the termination is illustrated in more detail in FIG. 3. The region of the composite rod reduced to its tow, or alternatively softened, either has resin re-applied and cured or has the softened resin re-hardened, to form a bend region, i.e. the termination, contiguous with the bundle of composite rods.

FIG. 4 illustrates that the same technique may produce bends suitable for redirecting the direction of pull through an otherwise linear support structure, such as happens in a sailboat stay where a vertical stay bends around a spreader end to contiguously become a diagonal stay.

As shown in FIG. 5, even a plug termination with higher strength and lower weight can be produced by the foregoing technique, where the bend region is the very end of the bundle of composite rods. As before, the bend region is reduced to its tow or the resin softened, the bend introduced, and then resin either added and cured or re-hardened.

The forgoing example structure, heating device, and method are described below in greater detail. Other means for reducing or removing the resin or other matrix include use of chemical or mechanical means, as mentioned above. Depending on the resin or other matrix used in construction of the rod, chemicals which soften or dissolve the resin or other matrix can be used, for example acid, etchants and solvents, or an accelerant to combine with heat. The chemicals may be applied to and/or removed from the desired region of the rod by any suitable known means. Alternatively, mechanical means, such as flexing the rod to crack and loosen the resin or other matrix, bending, impact, calendaring, ultrasonic fracturing, or impinging with microwaves, can be used on some structures instead of, or in combination with, heat or chemicals. Combinations of the foregoing methods, for example, using mechanical means to crack and loosen the matrix, followed by the use of chemicals and spray or washing action to complete the removal.

One way to generalize methods according to aspects of the invention includes describing the method as modifying the properties of a composite rod to bend at a different radius, either larger or smaller, than the unmodified rod.

Existing carbon composite rigging structures include a terminating eye formed by simply attaching a ring of fibers to a bundle of rods that have been flared to receive the ring of fibers and a flat paddle of fiber-reinforced matrix with a hole drilled through and similarly attached. Other known structures include either single rod, rather than a bundle of rods, or individual fibers, also rather than bundle of rods. An article of manufacture according to aspects of embodiments of the invention include a longitudinal stay structure having a continuous bundle of composite rods, a section of the continuous bundle of rods having a bend with a radius different from the characteristic bend radius of the bundle of rods.

Terminations and other sections of the stay structure having a bend radius different from the characteristic bend radius of the bundle of rods, especially including structures with bend radii smaller than the characteristic bend radius of the bundle of rods, can include an eye, double eyes, an eye with a bushing in the eye, an eye formed around a connector ball, an eye directly formed on a pin, spreader bond (arched support), etc. The opposite end of such a structure can include any type of termination, including another termination of the type described herein, or any other suitable termination.

During construction the cross-sectional layout of the bundle of rods can be patterned and maintained in a consistent pattern to the degree desired by locating rods in a separator plate or other methods of organization.

In some embodiments, the individual composite rods of a bundle of rods are not bonded to each other in any way. In other embodiments, the individual rods of a bundle of composite rods are lightly bonded to each other, for example by a flexible adhesive such as rubber cement. Any suitable form of bonding that permits flexion or movement between individual rods while stabilizing the bundle may be used in such embodiments.

Methods according to aspects of an embodiment of the invention can be practiced using an apparatus for injecting energy into a composite rod. As referred to above, one exemplary, non-limiting, composite rod includes a carbon fiber tow in a phenyl supporting matrix. For such a composite rod, energy can be injected by conducting an electric current through the carbon fiber of the tow to produce heat. The composite rod serves as a resistive heater wherein at least the carbon filament is conductive and the composite of fiber and supporting matrix is of sufficient resistance to create heat when a current is passed through a section of the composite rod. After sufficient exposure to the current, which can be constant or pulsed at an optimal voltage for the cross section of the composite rod, length of section and material properties of the composite, the temperature will reach a point at which the supporting matrix will break down, evaporate, or burn off and the carbon filament will remain, substantially undamaged. The exemplary heater includes a pair of contacts that applies a voltage to the rod segment that is to be bent in a radius different from the characteristic radius of the unmodified rod. Alternatively, the rod could be drawn through the contacts which are spaced a distance apart, and the current can be switched on and off depending on the length of section required to be modified or reduced to its tow. In order to avoid overheating the rod by injecting too much energy too fast and damaging the carbon fiber tow, the voltage may be manually pulsed by an operator while observing the effect, in the exemplary embodiment. Alternatively, the temperature of the segment to be modified can be monitored by any suitable means, such as a remote infrared sensor or a contact temperature sensor. It is desired to maintain a shallow temperature gradient across the length between the contacts. The contacts are spaced apart by the arc length of the bent segment to be formed, for example an eye termination. The required energy will be dependent on the thermal mass of the resin to be removed and the target time for removing resin. A temperature of 1,150° F. has been found by these inventors to work for phenyl resin. For any resin or other matrix, use any temperature lower than the temperature at which the carbon fibers degrade, which is around 1,400° F. Other constructions of rod material may require some experimentation to fine-tune the time, temperature, and voltage values to achieve the stated parameters.

One useful structure is a bundle of rods having eye terminations at each end as shown in FIG. 6.

In order to form a structure of a bundle of rods having eye terminations at each end, as shown in FIG. 6, an apparatus of the following description, as shown in FIGS. 9 and 10, can be used to wind a single rod into the desired structure. The apparatus includes at least one arc for which the bond is to be formed and located a distance apart corresponding to the finished length between the eye terminations of the stay structure. This arc, or arcs can be more elaborate to allow for the bond to be formed into a more desirable shape. The arcs are surrounded by a track carrying a spool on which the rod has been wound with a radius larger than the characteristic radius smaller than which the rod would suffer mechanical damage. Rod is unwound to form straight lengths between the eye termination locations. When each eye termination location is reached, the contacts of the heater are attached to the rod at locations corresponding to the arc from one side of the throat of the eye termination to the other side of the throat of the eye termination. After the resin is removed by application of heat, the heater contacts are removed and the rod can wind the modified segment from which the resin has been removed around the pin at a much smaller bend radius than the unmodified rod could be bent. After sufficient turns around the two pins have been made to provide the stay with the desired tensile strength, the molds are closed around the fibers of the eye terminations, and resin is injected and cured to form a continuous, solid structure without discontinuities between the fibers of the longitudinal portion of the stay between the eye terminations, and the fibers surrounding the hole of the eye termination.

Structures according to aspects of embodiments of the invention can include an eye termination or other termination as taught above at one end, and a flared termination as taught in U.S. Pat. No. 7,137,617 at the other. Such a structure can be made by cutting the stay with two eyes in half, as shown in FIGS. 7 and 8, and terminating the cut end with the flared termination as taught in U.S. Pat. No. 7,137,617, or as taught by the improvement herein.

What is claimed is:

1. A method of producing an integrated rigging component, comprising steps of:
providing at least one composite rod including a plurality of generally longitudinally oriented fibers and a supporting matrix generally surrounding and filling interstices between the plurality of generally longitudinally oriented fibers, the composite rod having a characteristic minimum bend radius;
modifying a characteristic of the supporting matrix along a section of the composite rod such that the section of the composite rod has a new minimum bend radius different from a characteristic minimum bend radius of an unmodified section of the composite rod;
bending the modified section of the composite rod; and
reintegrating supporting matrix along the modified section with matrix of the unmodified section.

2. The method of claim 1, wherein modifying further comprises:
removing a portion of the supporting matrix.

3. The method of claim 2, reintegrating further comprising:
embedding the modified section of the composite rod in a new supporting matrix contiguous with the unmodified section.

4. The method of claim 1, wherein modifying further comprises:
softening a portion of the supporting matrix.

5. The method of claim 4, further comprising:
re-hardening the supporting matrix of the modified section of the composite rod.

6. The method of claim 1, further comprising:
contacting the supporting matrix with a substance chemically reactive therewith, such that a physical property of the supporting matrix is modified.

7. The method of claim 1, further comprising:
contacting the supporting matrix with a solvent, such that a physical property of the supporting matrix is modified.

8. The method of claim 1, further comprising:
applying a mechanical force to the supporting matrix, such that a physical property of the supporting matrix is modified.

9. The method of claim 8, wherein applying a mechanical force comprises localized ultrasonic disruption of the supporting matrix.

10. The method of claim 1, further comprising:
heating the matrix at least sufficiently to modify a portion of the supporting matrix without substantially damaging the fibers.

11. The method of claim 10, wherein heating is at least sufficient to decompose the portion of the supporting matrix without substantially damaging the fibers.

12. The method of claim 11, heating further comprising:
conducting an electrical current through the fibers along the section of the composite rod.

13. The method of claim 11, heating further comprising:
applying a source of flame to the section of the composite rod.

14. The method of claim 11, heating further comprising:
directing a stream of heated fluid onto the section of the composite rod.

15. The method of claim 14, wherein the stream of heated fluid is blown hot air.

16. An article of manufacture comprising:
a bundle of composite rods, each composite rod including a plurality of generally longitudinally oriented fibers and a supporting matrix generally surrounding and filling interstices between the plurality of generally longitudinally oriented fibers, the composite rod having a characteristic minimum bend radius; and
a bend feature formed in a segment of the bundle of rods such that the bend has a bend radius different from the characteristic minimum bend radius, a combined plurality of generally longitudinally oriented fibers of the bundle of rods following the bend radius, and the combined plurality of generally longitudinally oriented fibers bonded together along the segment by a supporting matrix generally surrounding and filling interstices between the combined plurality of generally longitudinally oriented fibers.

17. The article of claim 16, wherein the bundle of rods includes a rod having unmodified segments, each to one side of the bend feature, the article further comprising:
a region in which the unmodified segments join contiguously with the segment of the rod in which the bend feature is formed.

18. The article of claim 17, further comprising a second bend feature having a modified segment of the rod joined contiguously with the unmodified segments.

19. The article of claim 17, further comprising:
a tapered termination in which the bundle of rods is embedded in a plug of supporting matrix having a tapered longitudinal profile.

20. The article of claim 16, the bend feature further comprising:
a tapered termination formed of the segment of the rod in which the bend feature is formed, and the unmodified segments join contiguously with the segment of the rod in which the bend feature is formed.
